(19) United States
(12) Patent Application Publication
(10) Pub. No.: US 2010/0270119 A1
(43) Pub. Date: Oct. 28, 2010

(54) Bill acceptor with a bill passage adjustment structure

(75) Inventor: Sheng-Yen Tsao, Taipei City (TW)

Correspondence Address: BACON & THOMAS, PLLC, 625 SLATERS LANE, FOURTH FLOOR, ALEXANDRIA, VA, 22314-1176, US

(73) Assignee: INTERNATIONAL CURRENCY TECHNOLOGIES CORPORATION, Taipei City (TW)

(21) Appl. No.: 12/385,892

(22) Filed: Apr. 23, 2009

(51) Int. Cl. G07F 7/04; G07D 7/16

(52) U.S. Cl. 194/206; 194/334

(57) ABSTRACT

A bill acceptor includes a bill acceptor body defining therein a bill passage, a bill slot panel mounted on the front side of the bill acceptor body and defining a bill insertion slot for the insertion of a bill into the bill passage, a bill box located on the rear side of the bill passage, a transmission mechanism for transferring an acceptable bill through the bill passage toward the bill box, a bill recognition unit for checking the authenticity and face value of an inserted bill, a bill pressing device for pushing each acceptable bill away from the bill passage into the inside of the bill box, two first adjustment devices for mounting on two opposite lateral sides of the bill passage to adjust the width of the bill passage to one of a set of bill passage widths, and two second adjustment devices for mounting on the inside of the bill slot panel at two opposite lateral sides relative to the bill insertion slot to adjust the width of the bill insertion slot subject to the bill passage width defined by the first adjustment devices.

### BACKGROUND OF THE INVENTION

1. Field of the Invention

The present invention relates to bill acceptors for parking, vending and gaming applications and more particularly, to such a bill acceptor with a bill passage adjustment structure.

2. Description of the Related Art

Following fast development of technology, our mode of living has been changed, and different automatic vending machines are used everywhere to sell different products without serviceman. These automatic vending machines are highly invited for the advantage of saving much labor and bringing convenience to people.

Further, the bill acceptor of a vending or gaming machine generally has a recognition device mounted therein for checking the authenticity and value of each inserted bill. However, the bill insertion slot and bill passage of a bill acceptor have a fixed width that is not adjustable to fit different kinds of bills. If the width of the bill insertion slot and bill passage of a bill acceptor does not fit the width of an acceptable bill perfectly, an acceptable bill may be biased after its insertion through the bill insertion slot into the bill passage. In this case, the recognition device of the bill acceptor may be unable to recognize the inserted bill accurately, and the inserted bill may be rejected due to a recognition error.

To prevent the aforesaid problem, bill acceptor providers will provide different bill acceptors specifically designed for use in different countries to fit different sizes of bills. However, preparing bill acceptors having different bill passage widths require different molds, complicating the manufacturing process and increasing the manufacturing cost. Further, preparing bill acceptors having different bill passage widths relatively increases the inventory cost.

Therefore, it is desirable to provide a bill acceptor that eliminates the aforesaid problems.

### SUMMARY OF THE INVENTION

The present invention has been accomplished under the circumstances in view. It is therefore the main object of the present invention to provide a bill acceptor, which allows adjustment of the bill passage width during fabrication, thereby saving the manufacturing cost and simplifying inventory control.

To achieve this and other objects of the present invention, the bill acceptor comprises a bill acceptor body, and a bill slot panel. The bill slot panel is mounted on the front side of the bill acceptor body, defining therein a bill insertion slot for the insertion of a bill. The bill acceptor body comprises a bill passage in communication with the bill insertion slot, a bill box located on the rear side of the bill passage, a transmission mechanism adapted for transferring an acceptable bill through the bill passage toward the bill box, a bill recognition unit adapted for checking the authenticity and face value of an inserted bill, and a bill pressing device adapted for pushing each acceptable bill away from the bill passage into the inside of the bill box, and two first adjustment devices for mounting on two opposite lateral sides of the bill passage to adjust the width of the bill passage to one of a set of bill passage widths.

Further, two second adjustment devices are mounted in the bill slot panel to adjust the width of the bill insertion slot subject to the bill passage width defined by the first adjustment devices.

### BRIEF DESCRIPTION OF THE DRAWINGS

FIG. 1 is an elevational view of a bill acceptor according to the present invention.

FIG. 2 is an exploded view of the bill acceptor in accordance with the present invention.

FIG. 3 is a sectional side view of the bill acceptor in accordance with the present invention

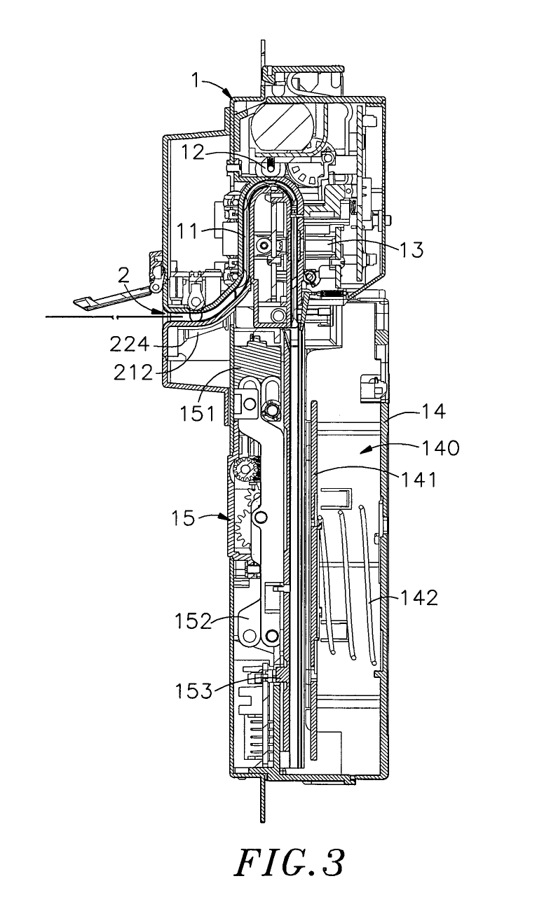

FIG. 4 is an exploded view of a part of the present invention, showing the structure of the first adjustment devices and the related locating blocks of the bill acceptor body.

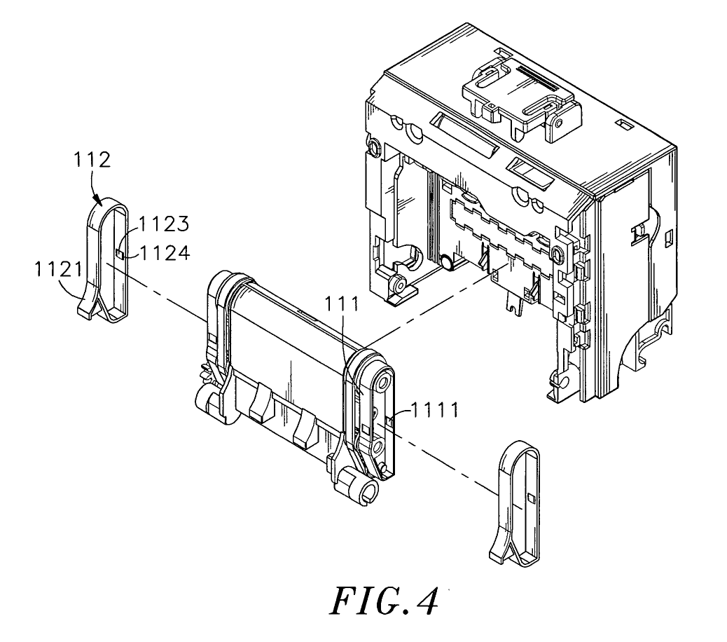

FIG. 5 is similar to FIG. 4 but showing an alternate form of the first adjustment devices.

FIG. 6 is an exploded view of the bill slot panel of the bill acceptor in accordance with the present invention, showing the structure of the second adjustment devices.

FIG. 7 is similar to FIG. 6 but showing an alternate form of the second adjustment devices.

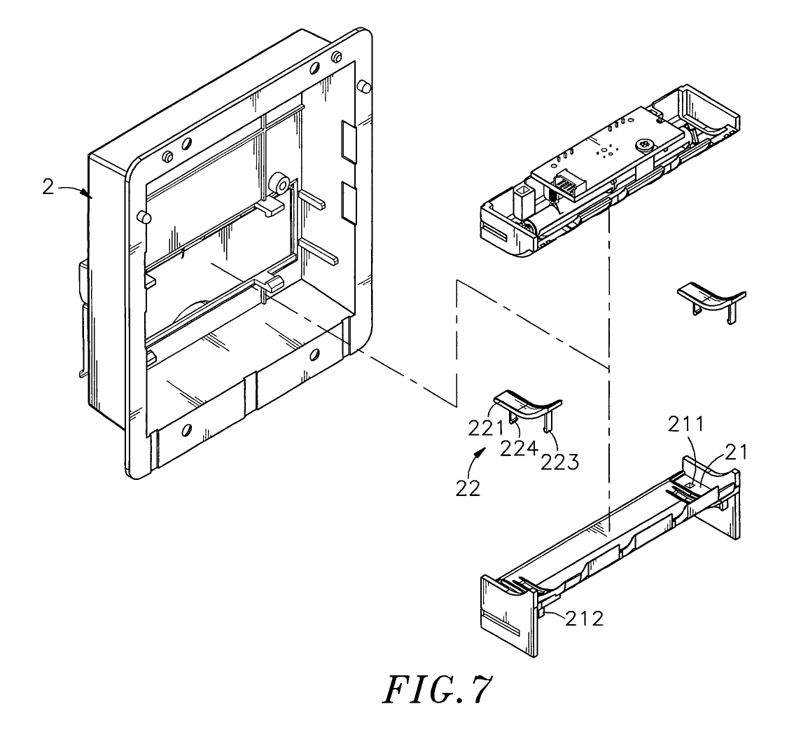

FIG. 8 is a perspective view of a part of the present invention, showing the width of the bill passage adjusted to the minimum size.

FIG. 9 is a perspective view of a part of the present invention, showing the width of the bill passage adjusted to the maximum size.

FIG. 10 is an exploded view of a part of the present invention, showing an alternate form of the positioning devices of the second adjustment devices.

FIG. 11 is an exploded view of a part of the present invention, showing still another mounting arrangement of the second adjustment devices.

FIG. 12 is an exploded view of the present invention, showing a stepped structure formed in the bill insertion slot of the bill slot panel.

### DETAILED DESCRIPTION OF THE PREFERRED EMBODIMENT

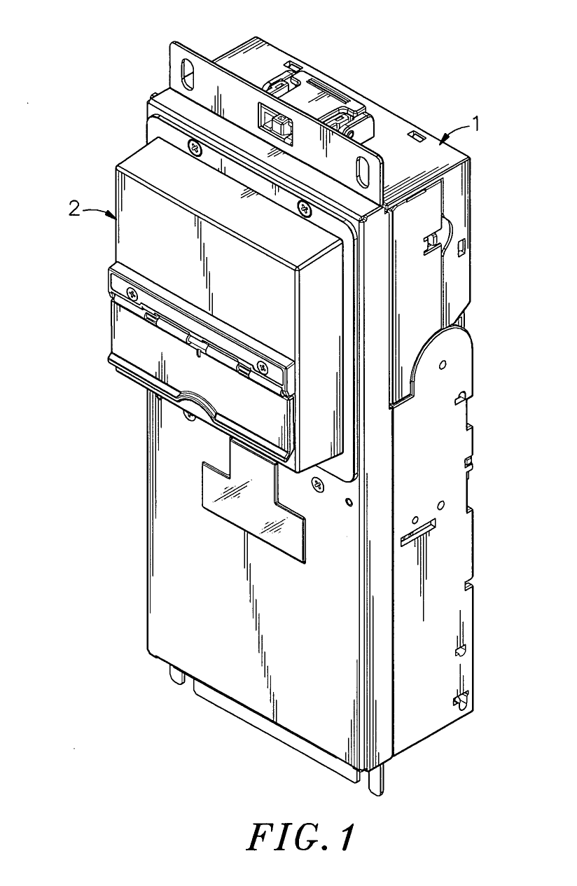

Referring to FIGS. 1˜4, a bill acceptor in accordance with the present invention is shown comprising a bill acceptor body 1 and a bill slot panel 2.

The bill acceptor body 1 comprises a bill passage 11, a bill box 14 located on the rear side of the bill passage 11, a transmission mechanism 12 adapted for transferring an acceptable bill being inserted through the bill slot panel 2 into the bill passage 11 to the bill box 14, a bill recognition unit 13 adapted for checking the authenticity and face value of each inserted bill, and a bill pressing device 15 adapted for pushing each acceptable bill away from the rear side of the bill passage 11 into the inside of the bill box 14. The bill acceptor body 1 further comprises two locating blocks 111 symmetrically arranged at two opposite lateral sides of the bill passage 11, and two first adjustment devices 112 respectively mounted on the locating blocks 111 and adapted for adjusting the width of the bill passage 11. Further, each locating block 111 has a plurality of locating grooves 1111. Further, each first adjustment device 112 comprises a mounting base 1121 fastened to the associating locating block 11. The mounting bases 1121 of the two first adjustment devices 112 define there between a standard bill passage width. The mounting base 1121 has a plurality of protruded retaining portions 1123 respectively forced into engagement with the locating grooves 1111 of the associating locating block 111. Further, each retaining portion 1123 has a beveled guide face 1124 at each of the two opposite lateral sides thereof to facilitate engagement of the respective retaining portion 1123 into the respective locating groove 1111.

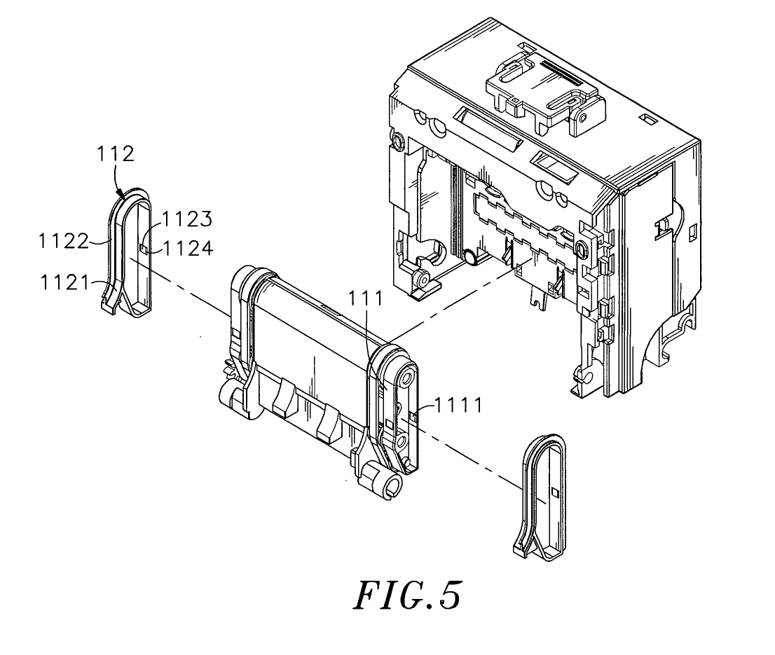

FIG. 5 shows an alternate form of the first adjustment devices 112. According to this alternate form, each first adjustment device 112 comprises a mounting base 1121, which has a plurality of protruded retaining portions 1123 with opposite beveled guide faces 1124 for engaging one locating groove 1111 of the associating locating block 111, and a protruding stop flange 1122 extending along one lateral side thereof. The mounting bases 1121 of the two first adjustment devices 112 can be interexchangeably mounted on the two locating blocks 111, i.e., the mounting bases 1121 of the two first adjustment devices 112 can be mounted on the two locating blocks 111 in either of two ways. The first way is that the mounting bases 1121 of the two first adjustment devices 112 are respectively mounted on the two locating blocks 111 to have the respective protruding stop flanges 1122 be disposed at an outer side so that a maximum bill passage width is defined between the protruding stop flanges 1122 of the first adjustment devices 112. The second way is that the mounting bases 1121 of the two first adjustment devices 112 are respectively mounted on the two locating blocks 111 to have the respective protruding stop flanges 1122 be disposed at an inner side so that a minimum bill passage width is defined between the protruding stop flanges 1122 of the first adjustment devices 112.

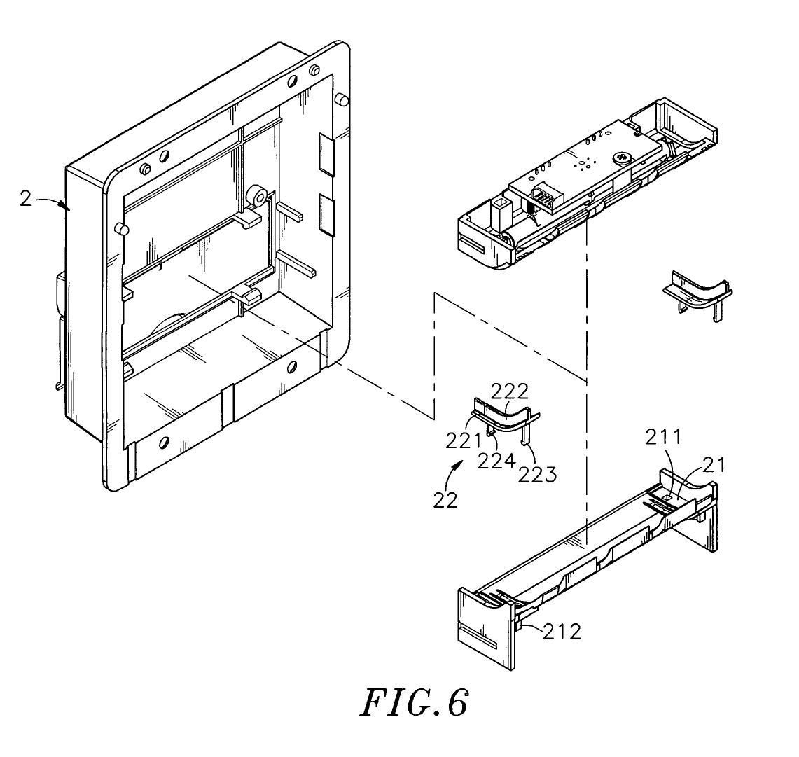

Referring to FIGS. 6˜9 and FIGS. 1˜3 again, the bill slot panel 2 is mounted on the front side of the bill acceptor body 1 remote from the bill box 14 and bill pressing device 15 for the insertion of a bill into the bill passage 11. The bill slot panel 2 comprises two locating portions 21 symmetrically arranged at two opposite lateral sides and respectively disposed in line with the two locating blocks 111 of the bill acceptor body 1, and two second adjustment devices 22 respectively mounted in the locating portions 21 and adapted for adjusting the width of the passage that guides an inserted bill from the bill insertion slot defined in the bill slot panel 2 to the bill passage 11. Further, each locating portion 21 has a plurality of through holes 211 and a bottom rack 212. Further, each second adjustment device 22 comprises a mounting base 221 fastened to the associating locating portion 21. The mounting bases 221 of the two second adjustment devices 22 define therebetween a standard sage width. The mounting base 221 has at least one positioning device 223. According to this embodiment, the mounting base 221 has multiple positioning devices 223 that are mounting rods respectively inserted through the through holes 221 of the associating locating portion 21. Each positioning device (mounting rod) 223 has a hooked portion 224 at the free end for hooking on the bottom rack 212 of the associating locating portion 21. Further, each second adjustment device 22 can be made having a protruding stop flange 222 extending along one lateral side of the mounting base 221 thereof (see FIG. 6) such that the mounting bases 221 of the two second adjustment devices 22 can be interexchangeably mounted on the two locating portions 21, i.e., the mounting bases 221 of the two second adjustment devices 22 can be mounted on the two locating portions 21 in either of two ways. The first way is that the mounting bases 221 of the two second adjustment devices 22 are respectively mounted on the two locating portions 21 to have the respective protruding stop flanges 222 be disposed at an outer side so that a maximum bill passage width is defined between the protruding stop flanges 222 of the second adjustment devices 22. The second way is that the mounting bases 221 of the two second adjustment devices 22 are respectively mounted on the two locating portions 21 to have the respective protruding stop flanges 222 be disposed at an inner side so that a minimum bill passage width is defined between the protruding stop flanges 222 of the second adjustment devices 22.

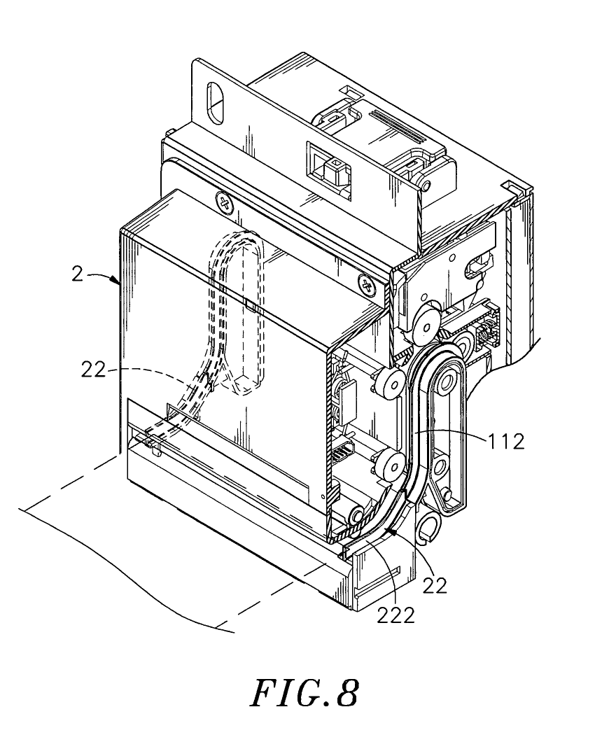

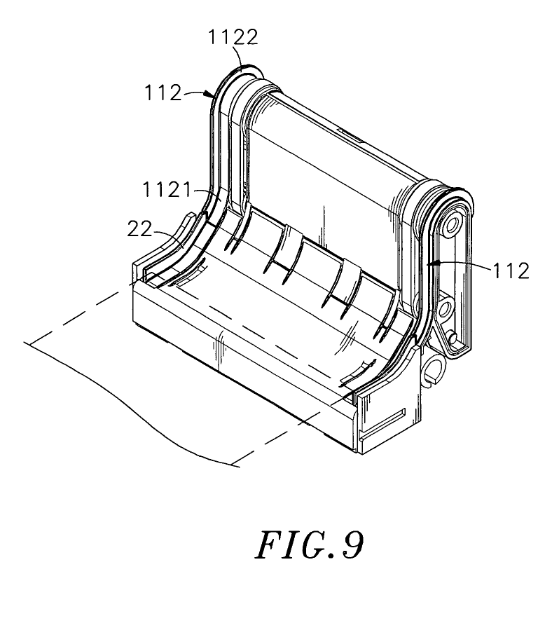

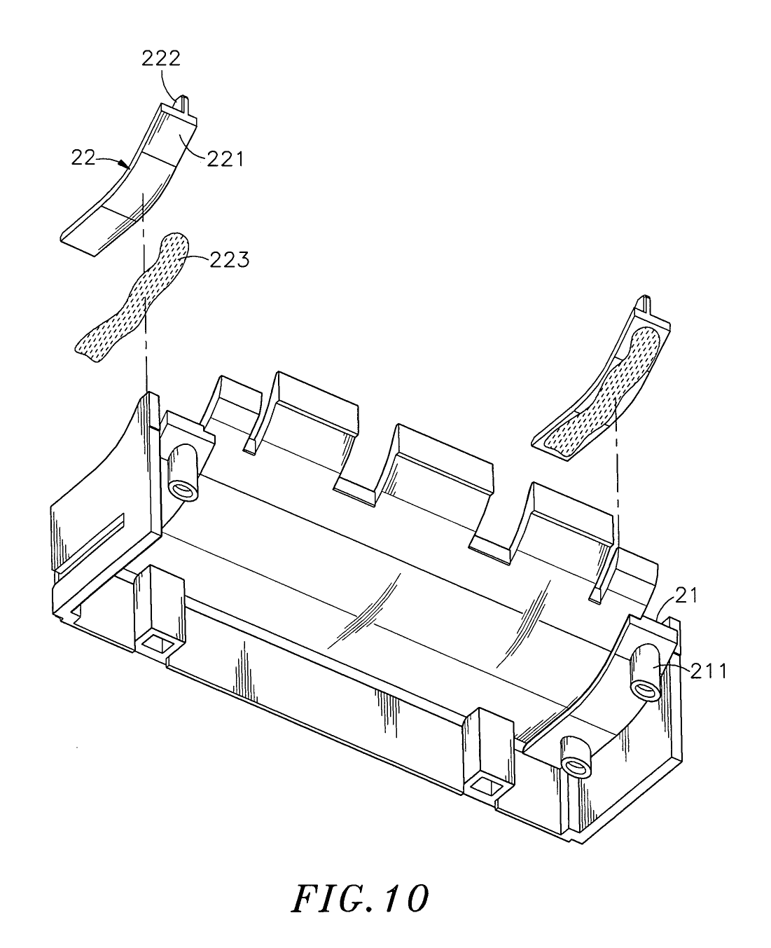

Referring to FIG. 10 and FIGS. 8 and 9 again, the positioning device 223 of the mounting base 221 of each second adjustment device 22 can be an adhesive (or double-sided adhesive tape) for bonding the mounting base 221 to the associating locating portion 21.

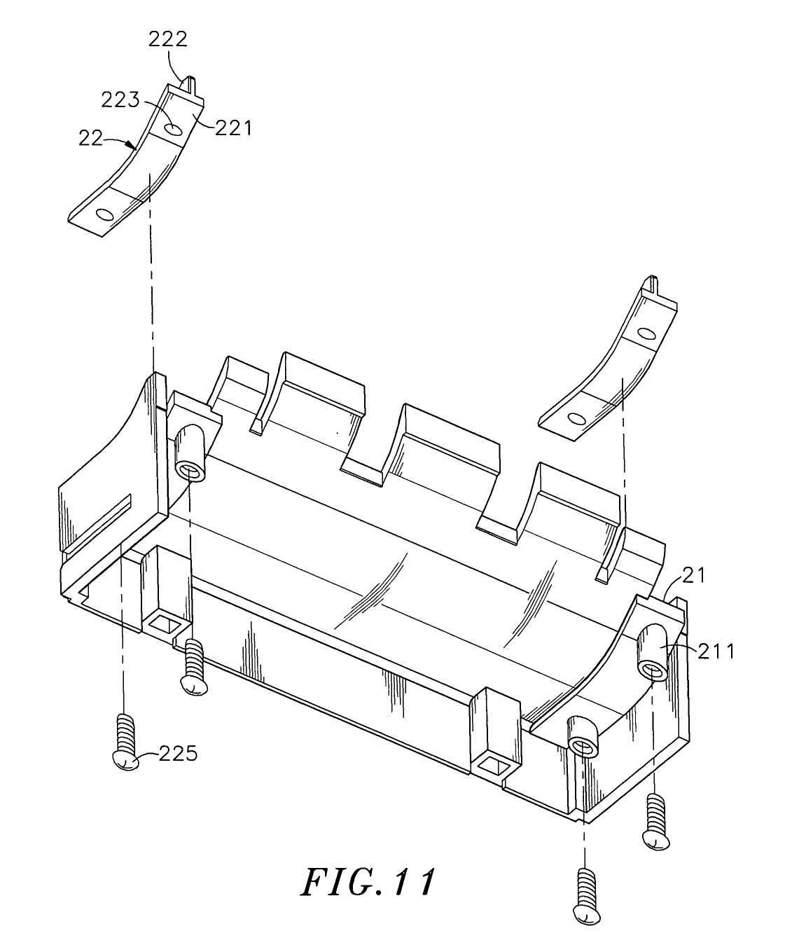

Referring to FIG. 11 and FIGS. 8 and 9 again, the positioning devices 223 of the mounting base 221 of each second adjustment device 22 can be mounting screw holes, and mounting screws 225 are upwardly inserted through the through holes 211 of the associating locating portion 21 and threaded into the positioning devices (mounting screw holes) 223 to affix the mounting base 221 to the associating locating portion 21.

Further, the first adjustment devices 112 can be installed in the locating blocks 111 in one of the aforesaid different measures employed to affix the second adjustment devices 22 to the locating portions 21. In conclusion, the first adjustment devices 112 and the second adjustment devices 22 can be fastened to the locating blocks 111 or locating portions 21 by adhesive means or hook means, or by means of screws, rivets, or any suitable known techniques or fastening devices.

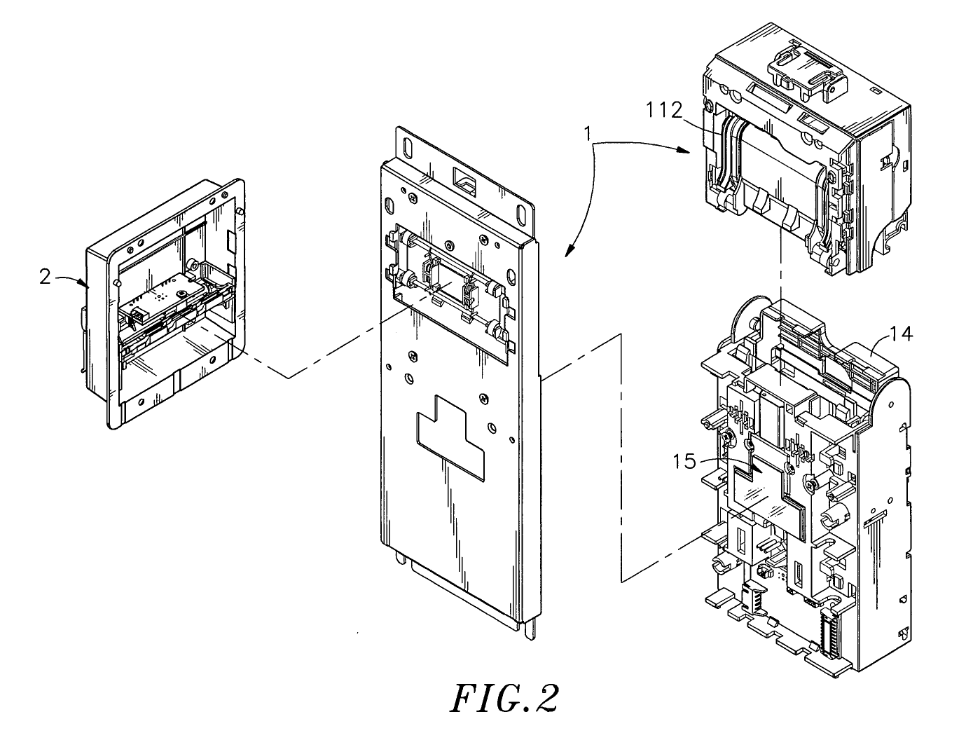

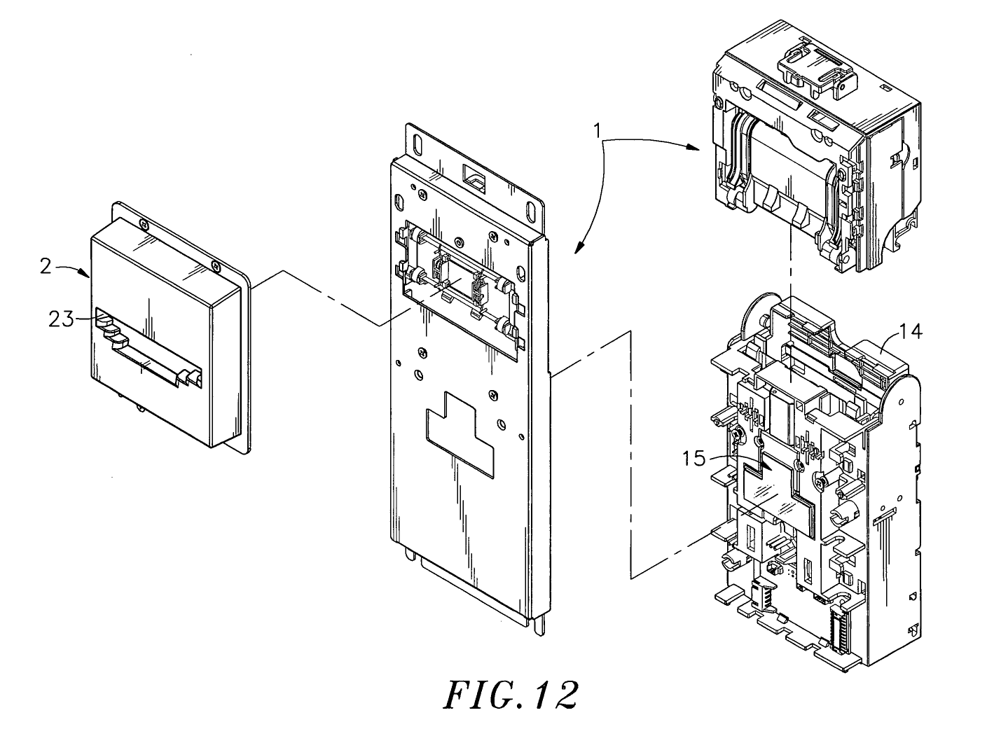

Referring to FIG. 12 and FIG. 2 again, the bill slot panel 2 has a stepped structure 23 in the bill insertion slot thereof to fit the aforesaid standard bill passage width, maximum bill passage width and minimum bill passage width.

As stated above, the invention provides a bill acceptor with a bill passage width adjustment function, which has the following advantages and features:

1. By means of using the first adjustment devices 112 of the bill acceptor body 1 and the second adjustment devices 22 of the bill slot panel 2, the bill passage width of the bill acceptor can be set in the factory in one of three sizes to fit different application requirements, thereby saving much tooling and inventory cost.

2. The first adjustment devices 112 as well as the second adjustment devices 22 are symmetrical. By means of exchanging the relative position between the first adjustment devices 112 and the relative position between the second adjustment devices 22, the bill passage width is relatively adjusted.

3. By means of using the first adjustment devices 112 and the second adjustment devices 22 to adjust the bill passage width for a particular size of bills, acceptable bills can be inserted into the bill passage 11 of the bill acceptor accurately without biasing for accurate recognition by the bill recognition unit 13, improving bill recognition success rate and accuracy.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A bill acceptor comprising a bill acceptor body, said bill acceptor body comprising a bill passage, a bill box located on a rear side of said bill passage, a transmission mechanism adapted for transferring an acceptable bill through said bill passage toward said bill box, a bill recognition unit adapted for checking the authenticity and face value of a bill being inserted into said bill passage, and a bill pressing device adapted for pushing each acceptable bill away from said bill passage into the inside of said bill box, wherein:
said bill acceptor body comprises two first adjustment devices for mounting on two opposite lateral sides of said bill passage to adjust the width of said bill passage to one of a set of bill passage widths.

2. The bill acceptor as claimed in claim 1, wherein said bill acceptor body comprises two locating blocks arranged at the two opposite lateral sides of said bill passage for holding said first adjustment devices; each said first adjustment device comprises a mounting base for fastening to one said locating block.

3. The bill acceptor as claimed in claim 2, wherein each said locating block comprises a plurality of locating grooves; each said mounting base of said first adjustment device comprises a plurality of protruded retaining portions for engaging the locating grooves of one said locating block.

4. The bill acceptor as claimed in claim 2, wherein each said protruded retaining portion comprises two beveled guide faces disposed at two opposite lateral sides thereof for guiding engagement of the respective protruded retaining portion into one locating groove of one said locating block.

5. The bill acceptor as claimed in claim 3, wherein said first adjustment devices are respectively fastened to said protruded retaining portions by an adhesive.

6. The bill acceptor as claimed in claim 2, wherein said first adjustment devices are fastened to said locating blocks by a hook joint.

7. The bill acceptor as claimed in claim 2, wherein said first adjustment devices are fastened to said locating blocks with screws.

8. The bill acceptor as claimed in claim 2, wherein said first adjustment devices are fastened to said locating blocks with rivets.

9. The bill acceptor as claimed in claim 2, wherein each said first adjustment device further comprises a protruding stop flange mounting base extending along one lateral side thereof for defining one of said set of bill passage widths.

10. A bill acceptor comprising a bill acceptor body, said bill acceptor body comprising a bill passage, a bill box located on a rear side of said bill passage, a transmission mechanism adapted for transferring an acceptable bill through said bill passage toward said bill box, a bill recognition unit adapted for checking the authenticity and face value of a bill being inserted into said bill passage, and a bill pressing device adapted for pushing each acceptable bill away from said bill passage into the inside of said bill box, and a bill slot panel mounted on a front side of said bill acceptor body and defining a bill insertion slot for the insertion of a bill into said bill passage, wherein:
said bill acceptor body comprises two first adjustment devices for mounting on two opposite lateral sides of said bill passage to adjust the width of said bill passage to one of a set of bill passage widths;
said bill slot panel comprises two second adjustment devices arranged at two opposite lateral sides relative to said bill insertion slot to adjust the width of said bill insertion slot subject to the width of said bill passage, each said second adjustment device comprising a mounting base and a positioning device for securing the mounting base inside said bill slot panel in position.

11. The bill acceptor as claimed in claim 10, wherein said bill acceptor body comprises two locating blocks arranged at the two opposite lateral sides of said bill passage for holding said first adjustment devices; each said first adjustment device comprises a mounting base for fastening to one said locating block; said bill slot panel further comprises two locating portions respectively disposed in line with said locating blocks of said bill acceptor body for receiving the positioning devices of said second adjustment devices to let the mounting bases of said second adjustment devices be supported on said locating portions.

12. The bill acceptor as claimed in claim 11, wherein each said locating block comprises a plurality of locating grooves; each said mounting base of said first adjustment device comprises a plurality of protruded retaining portions for engaging the locating grooves of one said locating block.

13. The bill acceptor as claimed in claim 12, wherein each said protruded retaining portion has two beveled guide faces disposed at two opposite lateral sides thereof for guiding engagement of the respective protruded retaining portion into one locating groove of one said locating block.

14. The bill acceptor as claimed in claim 12, wherein said first adjustment devices and said second adjustment devices are respectively fastened to said locating blocks and said protruded retaining portions by an adhesive.

15. The bill acceptor as claimed in claim 12, wherein said first adjustment devices and said second adjustment devices are respectively fastened to said locating blocks and said locating portions by a hook joint.

16. The bill acceptor as claimed in claim 12, wherein said first adjustment devices and said second adjustment devices are respectively fastened to said locating blocks and said locating portions with screws.

17. The bill acceptor as claimed in claim 12, wherein said first adjustment devices and said second adjustment devices are respectively fastened to said locating blocks and said locating portions with rivets.

18. The bill acceptor as claimed in claim 12, wherein each of said first adjustment devices and said second adjustment devices further comprises a protruding stop flange mounting base extending along one lateral side thereof for defining one of said set of bill passage widths.
